(19) United States
(12) Patent Application Publication
(10) Pub. No.: US 2018/0260777 A1
(43) Pub. Date: Sep. 13, 2018

(54) SECURE POSTAL DELIVERY SYSTEM HAVING A PERSONAL DELIVERY CODE AND METHOD

(71) Applicant: Daniel Judge, Albany, NY (US)

(72) Inventor: Daniel Judge, Albany, NY (US)

(21) Appl. No.: 15/674,486

(22) Filed: Aug. 10, 2017

Related U.S. Application Data
(60) Provisional application No. 62/469,062, filed on Mar. 9, 2017.

(51) Int. Cl. G06Q 10/08; G07C 9/00

(52) U.S. Cl. CPC G06Q 10/0836; G07C 9/0069

(57) ABSTRACT

A package delivery system includes a package depository, a package depository anchor, a camera, a doorbell, a mobile device, a personal user account, and a package delivery code. The package depository includes a lock which may be manipulated by a keypad or by an external signal. The independent devices may be connected using a local area network or wireless signal to complete an integrated delivery security system. The mobile device may be used to access the personal user account providing controls and security settings for operating the package depository. The package delivery system is useful for securing package deliveries and monitoring the delivery event.

### CROSS-REFERENCE TO RELATED APPLICATION(S)

The present application is related to and claims priority to U.S. Provisional Patent Application No. 62/469,062 filed Mar. 9, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of mail delivery means of existing art and more specifically relates to postal containers.

### RELATED ART

Mail, or post, is a system for physically transporting documents and other small packages; or, the postcards, letters, and parcels themselves. A postal service can be private or public, though many governments place restrictions on private systems. Since the mid-19th century national postal systems have generally been established as government monopolies with a fee on the article prepaid. Proof of payment is often in the form of adhesive postage stamps, but postage meters are also used for bulk mailing. Modern private postal systems are typically distinguished from national postal agencies by the names “courier” or “delivery service”.

Unfortunately, postal delivery customers are susceptible to mail theft when mail is delivered to their residence, especially when large parcels are delivered. Often mail is delivered when a recipient is away and may simply be deposited unsecured on a front porch or doorstep. This leaves parcels susceptible to theft. Some residences may include lockboxes for mail delivery, but these are generally only large enough for letters or very small parcels. Even if a lockbox is suitably large, a recipient may not be aware of a delivery made or be able to monitor the security of the delivery. A suitable solution is desired.

U.S. Pat. No. 6,967,575 to Steve H. Dohrmann et al. relates to methods and an apparatus for unattended pickups and deliveries. The described methods and apparatus for unattended pickups and deliveries include a secure pickup and delivery container having a lockable door, a control unit, an access element, and an anchoring element, according to one embodiment. The control unit includes a processing element and a memory that can be programmed either on-site or remotely with access privilege information such as identity (e.g. of container, delivery person, etc.), location, date, time, frequency of access, and/or package-specific information. In one embodiment, access privilege information is programmed when an intended recipient of a delivery consummates a point of sale transaction, for example over the Internet or telephone. The access element can be a keypad, a biometric scanner, a card reader, a bar-code reader, and/or a wireless control element to read a programmable token such as a smart card. Delivery personnel can enter access request information into the access element, and if it favorably compares with the access privilege information, the control unit unlocks the door.

### SUMMARY OF THE INVENTION

In view of the foregoing disadvantages inherent in the known postal container art, the present disclosure provides a novel secure postal delivery system having a package delivery code. The general purpose of the present disclosure, which will be described subsequently in greater detail, is to provide an efficient and secure postal delivery system having a package delivery code.

A package delivery system is disclosed herein. The package delivery system includes a package depository, a package depository anchor, a camera, a doorbell, a mobile device, a personal user account, and a package delivery code. The package depository includes a mechanical lock, a keypad in electrically connected to the mechanical lock, and a transceiver electrically connected to the mechanical lock and the keypad. The package depository anchor attaches to the bottom of the securable package depository to affix it to the ground, a platform, or other secure structure. The camera is electrically connected to the transceiver so that it can record footage of the package depository when the keypad is activated. The doorbell is also electrically connected to the transceiver of the package depository, such that it can be made to ring when prompted by the transceiver.

The mobile device may wirelessly communicate with the transceiver, while the personal user account is accessible from the mobile device, in such a way that the mobile device may be used to manipulate the package depository. The personal user account is securable with a username and password so that unauthorized users may not manipulate the package depository.

The package delivery code is a unique number that may be assigned to a delivery, and entered into the keypad by a postman to unlock the package depository and deposit a previously authorized delivery.

According to another embodiment, a method of securely delivering a package is also disclosed herein. The method of securely delivering a package includes assigning a package delivery code to a mail order for a specific delivery location, delivering the mail order to the location, entering the package delivery code into the keypad, depositing the mail order in the package depository, logging a delivery notification electronically and automatically, sending a delivery notification to the personal user account, recording the delivery event on the camera, reviewing footage of the delivery event, and lastly, retrieving the mail order from the package depository.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a secure postal delivery system having a package delivery code, constructed and operative according to the teachings of the present disclosure.

FIG. 1 is a perspective view of the package delivery system according to an embodiment of the disclosure.

FIG. 2 is a perspective view of the package delivery system of FIG. 1 detailing the package depository, according to an embodiment of the present disclosure.

FIG. 3 is a perspective view of the package delivery system of FIG. 1 during an ‘in-use’ condition, according to an embodiment of the present disclosure.

FIG. 4 is a perspective view of the package delivery system of FIG. 1 detailing the local area network and the home security router, according to an embodiment of the present disclosure.

FIG. 5 is a flow diagram illustrating a method of use for securely delivering a package, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a postal container and more particularly to a secure postal delivery system having a package delivery code as used to improve the security of delivering a package.

Generally, the secure postal delivery system having a package delivery code provides users with a smart and secure mail and parcel delivery container integrated into a tracking and monitoring system, keeping deliveries safe at a home, at business, at government buildings, and much more. The system reduces the chance of a mail delivery being stolen, effectively preventing serious cases of identity theft. The parcel delivery container syncs wirelessly with a smartphone or other mobile device, allowing users to monitor a doorbell camera installed with the postal delivery system using the device. The system also features a coded key pad lock that can be opened or closed via a postal delivery code or by using a mobile device with or without a home security router. The mobile device may access a secure user portal which allows the user to monitor and control all functions of the package delivery system. Preferably, all of the functions of the package delivery system operate wirelessly, particularly the camera, the doorbell, the mobile device, and the parcel delivery container lock. The present invention decreases the number of unsuccessful delivery attempts while eliminating the need to go to a postal service location if a parcel is unable to be left by delivery personnel.

The secure postal delivery system having a package delivery code includes a safe, secure, and convenient storage container for delivered packages and mail. The device is a secure container capable of being locked/unlocked using a keypad, an internal mechanical lock, and/or a doorbell identifying system preferably facilitated through a wireless network. The programmable key pad lock can be opened and closed by entering the postal delivery code or by using a smartphone and home security router. A standard key may also be used to operate the lock.

The wireless doorbell system includes at least one camera which enables the owner to view and identify who is presently at the package box. The box may be unlocked wirelessly by the owner if he/she deems the person near the container to be delivery personnel. In some embodiments, the package delivery system may further include a motion detector to notify a user when a delivery person is present. In some embodiments, the motion detector may activate the doorbell when a delivery person is present. The package can be placed inside and secured via a fastening device. An alternative method to opening the box may be through the package delivery code. A customer can provide the package delivery code when ordering an item. The delivery personnel can then enter the package delivery code into the container when depositing and delivering the parcel. The package delivery system may be usable with both private and government postal services. No matter the method used to receive packages, the package delivery system effectively ensures safe and secure delivery, even when the owner is away from home. The package delivery system can be constructed using wood, plastic, and other suitable materials. The device may be made in various sizes in order to accommodate all user needs and preferences.

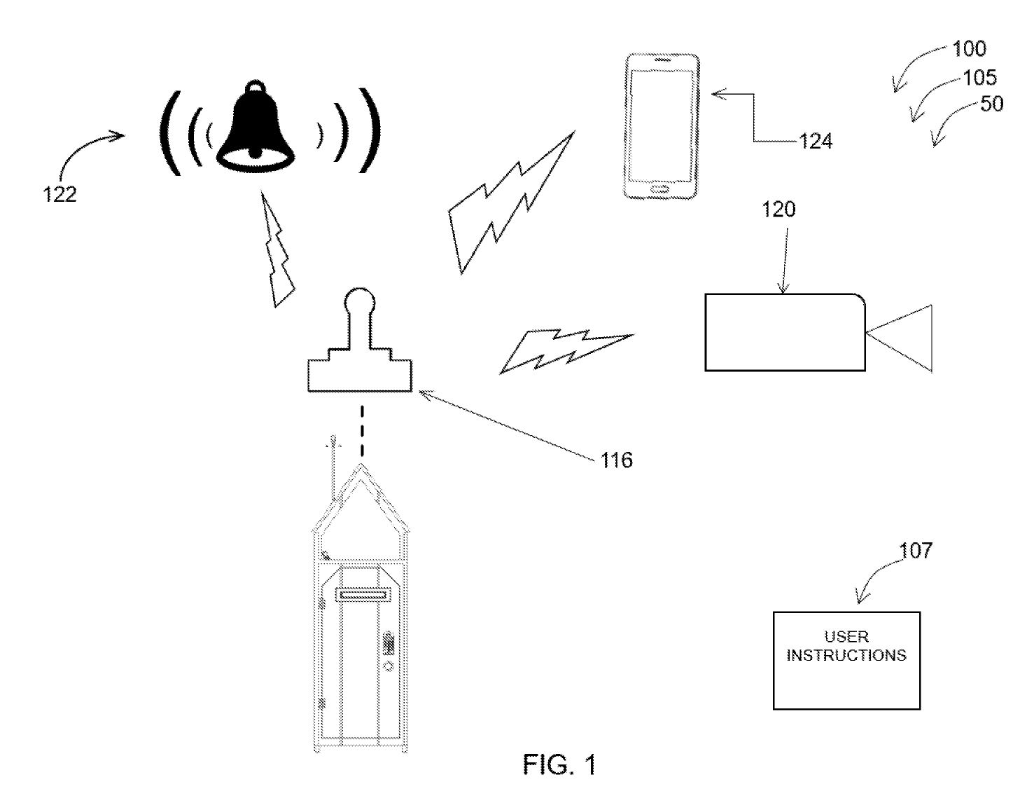

Referring now more specifically to the drawings by numerals of reference, there is shown in FIGS. 1-4, various views of a package delivery system 100.

FIG. 1 shows a package delivery system 100 during an ‘in-use’ condition 50, according to an embodiment of the present disclosure. Here, the package delivery system 100 may be beneficial to provide a delivery means for a customer with a secure package delivering/receiving system. As illustrated, the package delivery system 100 may include transceiver 116, camera 120, doorbell 122, and mobile device 124. Camera 120, doorbell 122, and mobile device 124 are in communication with transceiver 116. Camera 120 is in wireless communication with transceiver 116 and is configured to recorded visual and audio footage. Doorbell 122 is in wireless communication with transceiver 116, and is configured to ring when prompted by transceiver 116. Mobile device 124 is also in wireless communication with transceiver 116. Alternate embodiments may use wired means for communication between devices in the system 100. Upon reading this specification, it should be appreciated that, under appropriate circumstances, considering such issues as user preferences, design preference, structural requirements, marketing preferences, cost, available materials, technological advances, etc., other physical arrangements such as, for example, the type(s) of camera used may be changed, the construction of the depository may be altered for specific application, etc., may be sufficient.

According to one embodiment, the package delivery system 100 may be arranged as a kit 105. In particular, the package delivery system 100 may further include a set of instructions 107. The instructions 107 may detail functional relationships in relation to the structure of the package delivery system 100 such that the package delivery system 100 can be used, maintained, or the like, in a preferred manner.

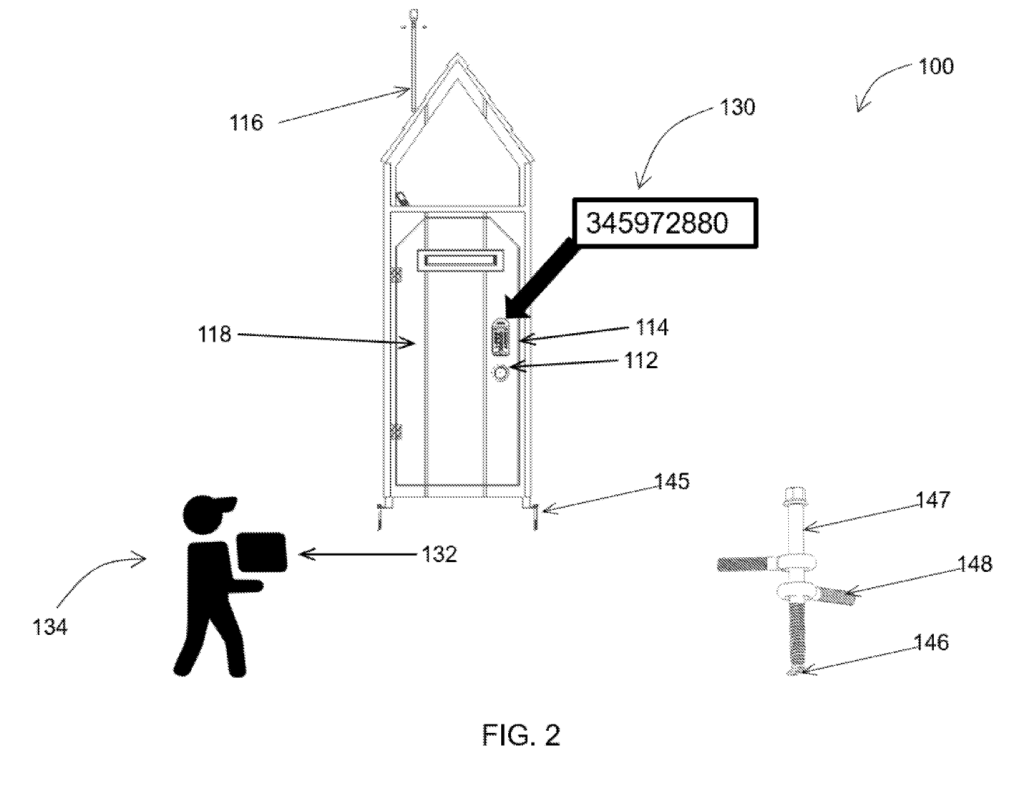

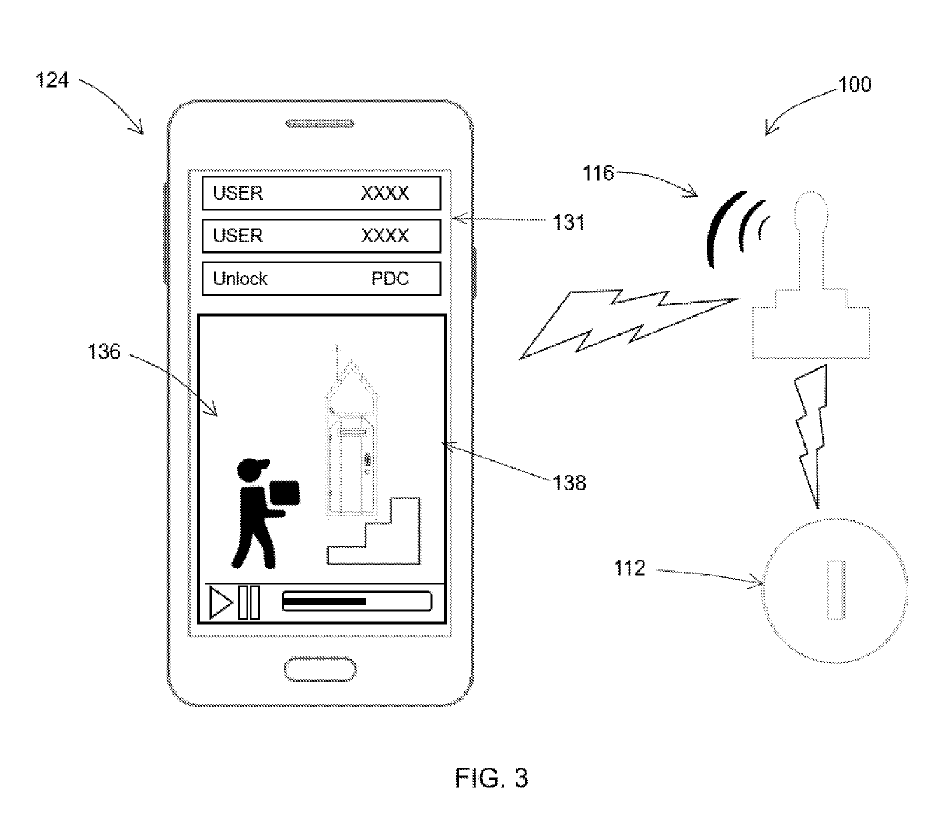

FIG. 2 shows the package delivery system of FIG. 1, according to an embodiment of the present disclosure. The package delivery system 100 may further include package depository 110, anchor 145, and package delivery code 130. Package depository 110 includes mechanical lock 112, keypad 114 in communication with mechanical lock 112, and transceiver 116 in communication with mechanical lock 112 and keypad 114. Package delivery code 130 may be temporarily associated with delivery event 136 (FIG. 3), which may be entered using keypad 114 of package depository 110 to unlock mechanical lock 112 of package depository 110. Package delivery code 130 is assigned to mail order 132 by the delivery customer.

Mail order 132 may be an online order. Package delivery code 130 is disclosed to a postal delivery service, package delivery code 130 being correlated to a specified mail order 132, such that package delivery code 130 may be entered by postal delivery service 134 into keypad 114 of package depository 110 when depositing mail order 132. Package depository 110 further includes a receptacle defining an inner volume for storing packages including a hinged door, the hinged door being latched by mechanical lock 112 of package depository 110. Package depository anchor 145 further preferably includes a corkscrew-profile configured to fasten into soil (volume) and a threaded fastener attached to corkscrew 146 configured to attach package depository 110 to package depository anchor 145. Package depository anchor 145 further includes handles attached to corkscrew 146 configured to turn corkscrew 146 for screwing into soil.

Referring now to FIG. 3, a perspective view of the package delivery system 100 of FIG. 1, according to an embodiment of the present disclosure. Package delivery system 100 may further include a mobile device application configured to access the personal user account 131. Camera 120 (FIG. 1) is in wireless communication with transceiver 116 of package depository 110 configured to record video footage 138 of delivery event 136. Personal user account 131 stores and accesses video and audio footage recorded by camera 120 (FIG. 1). Personal user account 131 is accessible from mobile device 124 having and controls package depository 110, personal user account 131 being configured to provide secure access for user 40 of package delivery system 100. Mobile device 124 may be used to lock and alternatively unlock mechanical lock 112 of the package deposit. Mobile device 124 may be used to review video footage 138 of delivery event 136.

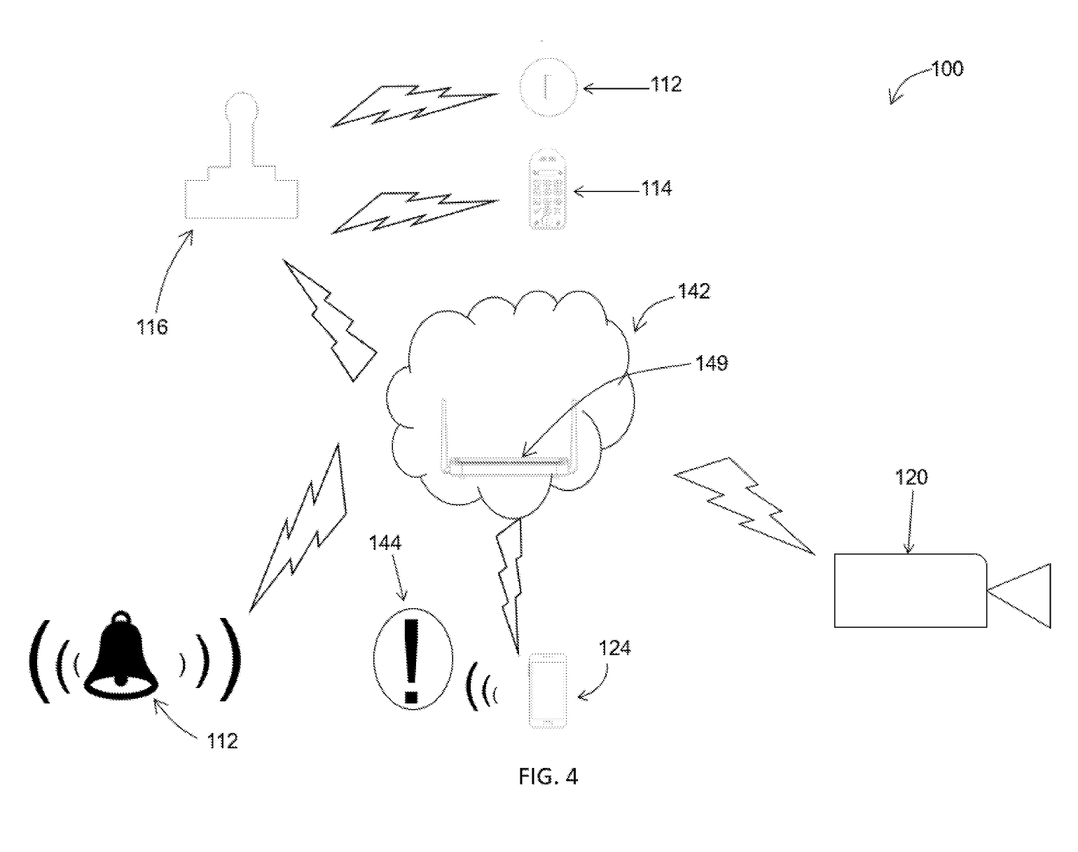

FIG. 4 is a perspective view of the package delivery system 100 of FIG. 1, according to an embodiment of the present disclosure. Package delivery system 100 further includes home security router 149, wherein home security router 149 is in wireless communication with transceiver 116 of package depository 110; wherein home security router 149 is configured to send control signals to transceiver 116 of package depository 110. Transceiver 116 of package depository 110, doorbell 122, camera 120, and mobile device 124 are wirelessly connected using an 802.11 local area network 142. Transceiver 116 prompts doorbell 122 to ring when package delivery code 130 (FIG. 2) is entered into keypad 114 of package depository 110. Transceiver 116 prompts mobile device 124 to issue a notification 144 and alternatively ring when a personal delivery code is entered into keypad 114 of package depository 110.

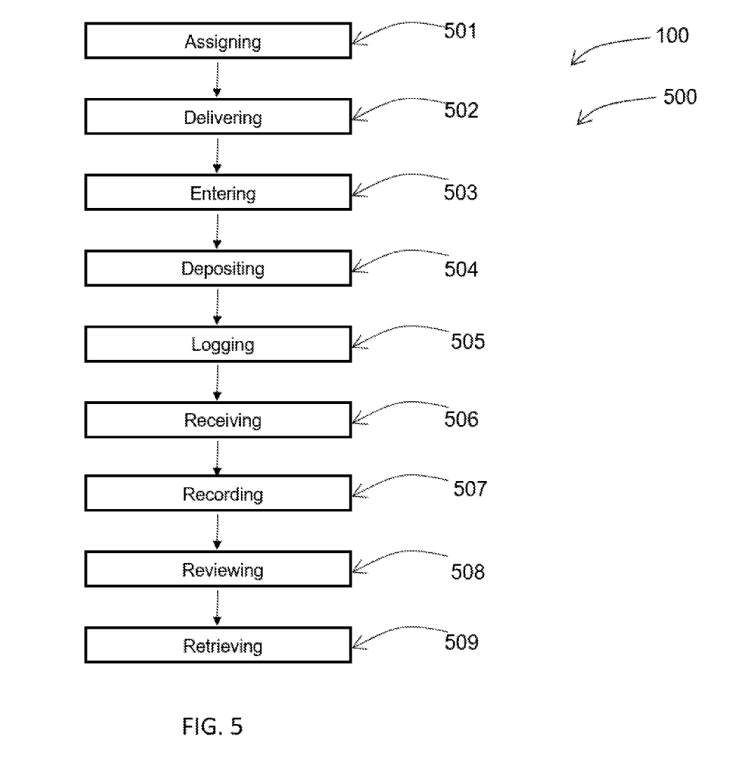

FIG. 5 is a flow diagram illustrating a method for securely delivering a package, according to an embodiment of the present disclosure. In particular, the method for securely delivering a package 500 may include one or more components or features of the package delivery system 100 as described above. As illustrated, the method for securely delivering a package 500 may include the steps of: step one 501, assigning a package delivery code to a mail order; wherein the package delivery code is correlated to a specified package depository at a specified location; step two 502, delivering a mail order to the location; step three 503, entering the package delivery code using a keypad attached to the package depository at the location; step four 504, entering the package delivery code using a keypad attached to the package depository at the location; step five 505, depositing the mail order in the package depository; step six 506, logging a delivery notification; step seven 507, receiving a delivery notification via a personal user account; step eight 508, recording a delivery event on a camera; step nine 509, reviewing footage of the delivery event; and step ten 510, retrieving the mail order from the package depository.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for securely delivering a package, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A package delivery system, the system comprising:
a package depository having a mechanical lock, a keypad in communication with the mechanical lock, and a transceiver in communication with the mechanical lock and the keypad;
a package depository anchor configured to affix the securable package depository to a ground and alternatively a fixed structure;
a camera in wireless communication with the transceiver of the package depository configured to record video footage of a delivery event;
a doorbell in wireless communication with the transceiver of the package depository configured to ring when prompted by the transceiver of the package depository;
a mobile device in wireless communication with the transceiver of the package depository;
a personal user account accessible from the mobile device having controls for the package depository, the personal user account being configured to provide secure access to an owner of the package delivery system; and
a package delivery code which may be temporarily associated with a delivery, which may be entered using the keypad of the package depository to unlock the mechanical lock of the package depository.

2. The package delivery system of claim 1, wherein the package delivery code is assigned to a mail order by a delivery customer.

3. The package delivery system of claim 2, wherein the mail order is an online order.

4. The package delivery system of claim 2, wherein the package delivery code is disclosed to a postal delivery service, the package delivery code being correlated to a specified mail order, such that the package delivery code may be entered by the postal delivery service into the keypad of the package depository when depositing the mail order.

5. The package delivery system of claim 1, further including a mobile device application configured to access the personal user account.

6. The package delivery system of claim 5, wherein the camera transmits recorded video and audio footage of a delivery event.

7. The package delivery system of claim 5, wherein the personal user account stores and accesses video and audio footage recorded by the camera.

8. The package delivery system of claim 5, wherein the mobile device may be used to lock and alternatively unlock the mechanical lock of the package deposit.

9. The package delivery system of claim 5, wherein the mobile device may be used to review video and audio footage from the camera.

10. The package delivery system of claim 1, wherein the package delivery system further includes a home security router, wherein the home security router is in wireless communication with the transceiver of the package depository, wherein the home security router is configured to send control signals to the transceiver of the package depository.

11. The package delivery system of claim 1, wherein the transceiver of the package depository, the doorbell, the camera, and the mobile device are wirelessly connected using an 802.11 local area network.

12. The package delivery system of claim 1, wherein the transceiver prompts the doorbell to ring when a package delivery code is entered into the keypad of the package depository.

13. The package delivery system of claim 1, wherein the transceiver prompts the mobile device to issue a notification and alternatively ring when a package delivery code is entered into the keypad of the package depository.

14. The package delivery system of claim 1, wherein the package depository further includes a receptacle defining an inner volume for storing packages including a hinged door, the hinged door being latched by the mechanical lock of the package depository.

15. The package delivery system of claim 1, wherein the package depository anchor includes a corkscrew configured to fasten into soil and a threaded fastener attached to the corkscrew configured to attach the package depository to the package depository anchor;

16. The package delivery system of claim 14, wherein the package depository anchor further includes handles attached to the corkscrew configured to turn the corkscrew for screwing into soil.

17. The package delivery system of claim 1, wherein the use of the package delivery code and alternatively use of the package delivery system for an individual delivery must be approved by a patent holder of the package delivery system.

18. A secure package delivery system having a package delivery code, the package delivery system comprising:
a package depository having a mechanical lock, a keypad in communication with the mechanical lock, and a transceiver in communication with the mechanical lock and the keypad;
a package depository anchor configured to affix the securable package depository to a ground and alternatively a fixed structure;
a camera in wireless communication with the transceiver of the package depository configured to record video footage of a delivery event;
a doorbell in wireless communication with the transceiver of the package depository configured to ring when prompted by the transceiver of the package depository;
a mobile device in wireless communication with the transceiver of the package depository;
a personal user account accessible from the mobile device having controls for the package depository, the personal user account being configured to provide secure access to an owner of the package delivery system; and
a package delivery code which may be temporarily associated with a delivery, which may be entered using the keypad of the package depository to unlock the mechanical lock of the package depository;
wherein the package delivery code is assigned to a mail order by a delivery customer;
wherein the mail order is an online order;
wherein the package delivery code is disclosed to a postal delivery service, the package delivery code being correlated to a specified mail order, such that the package delivery code may be entered by the postal delivery service into the keypad of the package depository when depositing the mail order;
wherein the secure package delivery system further includes a mobile device application configured to access the personal user account;
wherein the camera transmits recorded video and audio footage of a delivery event;
wherein the personal user account stores and accesses video and audio footage recorded by the camera;
wherein the mobile device may be used to lock and alternatively unlock the mechanical lock of the package deposit;
wherein the mobile device may be used to review video and audio footage from the camera;
wherein the package delivery system further includes a home security router;
wherein the home security router is in wireless communication with the transceiver of the package depository, wherein the home security router is configured to send control signals to the transceiver of the package depository;
wherein the transceiver of the package depository, the doorbell, the camera, and the mobile device are wirelessly connected using an 802.11 local area network;
wherein the transceiver prompts the doorbell to ring when a package delivery code is entered into the keypad of the package depository;
wherein the transceiver prompts the mobile device to issue a notification and alternatively ring when the package delivery code is entered into the keypad of the package depository;
wherein the package depository further includes a receptacle defining an inner volume for storing packages including a hinged door, the hinged door being latched by the mechanical lock of the package depository;
wherein the package depository anchor includes a corkscrew configured to fasten into soil and a threaded fastener attached to the corkscrew configured to attach the package depository to the package depository anchor; and
wherein the package depository anchor further includes handles attached to the corkscrew configured to turn the corkscrew for screwing into soil.

19. The package delivery system of claim 18, further comprising set of instructions; and
wherein the package delivery system is arranged as a kit.

20. A method of securely delivering a package, the method comprising the steps of:
assigning a package delivery code to a mail order, wherein the package delivery code is correlated to a specified package depository at a specified location;
delivering a mail order to the location;
entering the package delivery code using a keypad attached to the package depository at the location;
depositing the mail order in the package depository;
logging a delivery notification;
receiving a delivery notification via a personal user account;
recording a delivery event on a camera;
reviewing footage of the delivery event;
retrieving the mail order from the package depository; and
opening the mechanical lock of the package depository with a mechanical key.
